(19) United States
(12) Patent Application Publication
(10) Pub. No.: US 2025/0064241 A1
(43) Pub. Date: Feb. 27, 2025

(54) FLOOR MAT

(71) Applicant: ALADDIN MANUFACTURING CORPORATION, Calhoun, GA (US)

(72) Inventor: Chunming LIU, Calhoun, GA (US)

(21) Appl. No.: 18/717,897

(22) PCT Filed: Nov. 25, 2022
(86) PCT No.: PCT/IB2022/061416

§ 371 Date: Jun. 7, 2024

Related U.S. Application Data
(60) Provisional application No. 63/287,821, filed on Dec. 9, 2021.

(51) Int. Cl. A47G 27/02; B29C 33/58; B29C 43/02; B29C 43/20; B29C 43/52; B29K 75/00; B29K 105/12; B29K 675/00; B29L 31/00; B32B 3/04; B32B 3/08; B32B 3/30; B32B 5/02; B32B 5/18; B32B 5/24; B32B 5/32

(52) U.S. Cl. CPC A47G 27/0231; B29C 33/58; B29C 43/021; B29C 43/203; B29C 43/52; B32B 3/04; B32B 3/085; B32B 3/30; B32B 5/02; B32B 5/18; B32B 5/245; B32B 5/32; B29K 2075/00; B29K 2105/128; B29K 2675/00; B29L 2031/7324; B32B 2262/0292; B32B 2266/0278; B32B 2266/12; B32B 2471/04

(57) ABSTRACT

The present invention relates to a floor mat comprising a substrate layer, a gel layer and a cover layer, wherein said substrate layer, said gel layer and said cover layer have a substantially planar shape, and wherein said gel layer is coupled in between said substrate layer and said cover layer, and wherein the cover layer comprises a plurality of deformations, which deformations protrude at least partly towards the center of the gel layer. In further aspects, the invention relates to a floor mat wherein the thickness of the gel layer and the thickness of the substrate layer are related according to a ratio of between 1:20 and 20:20, as well as to methods for manufacturing a floor mat.

The invention relates to a floor mat. More in particular, the invention relates to a floor mat which improves support and/or comfort towards a subject standing and/or walking on the floor mat.

Floor mats for providing support and/or comfort towards a subject are known in the art, and generally consist of foam materials. Such foam materials may however lose their anti-fatigue properties as air cells may compress and/or collapse over time, and thus become less usable when such floor mats get older. Floor mats comprising alternative materials, such as gel-based materials, are for example described in U.S. Pat. No. 9,452,597 B2. Herein, a pre-formed gel cushion member is used for providing anti-fatigue properties to the floor mat. Manufacturing of floor mats comprising gel-based materials can however be less straight-forward, and it may be difficult to obtain a floor mat which has all desired properties regarding firmness and stability on one hand, and softness and comfort on the other hand, and/or which can withstand heavy duty.

The present invention aims to solve at least one of the aforementioned problems and/or disadvantages.

A first independent aspect of the present invention aims at providing a floor mat, said floor mat comprises a substrate layer, a gel layer and a cover layer, wherein said substrate layer, said gel layer and said cover layer have a substantially planar shape, and wherein said gel layer is coupled in between said substrate layer and said cover layer. The floor mat according to the first independent aspect of the invention is characterized by the cover layer comprising a plurality of deformations, which deformations protrude at least partly towards the center of the gel layer.

The wording “deformation” herein indicates any change in shape which deviates from the general, substantially planar shape of the layers, in particular of the cover layer. Deformations as such may comprise, without being limited thereto, protrusions, slits, holes, recesses, bumps etc.

The floor mat according to the present invention aims at improving comfort for a subject walking and/or standing on the floor mat, wherein the deformations which protrude at least partly towards the center of the gel layer, allow to better distribute forces throughout the gel layer, to at least partly stabilize the gel layer's shape and/or to keep the gel layer better in place when a subjects stands and/or walks on the floor mat. Improved comfort is especially relevant in working environments wherein a subject has to stand upright during longer periods of time. The floor mat thus contributes to a more ergonomic working environment and to the well-being of a subject.

By preference, said deformations protrude towards the center of the gel layer over a distance of between 1.0% and 20.0% of the total thickness of said gel layer. Within said range, optimal stability and comfort is achieved and higher ratios of gel material to substrate material can be applied. As such, the comfort provided to a subject is further improved, without the floor mat getting unstable and/or without the floor mat bending through and/or moving too much when a subject is walking and/or standing on the floor mat. A particular advantage of the floor mat as described herein thus exists in that an optimal balance between stability and comfort is found. Furthermore, to be practical in use, the floor mat is preferably not too thick, i.e. to allow a subject to easily stand and/or walk on the floor mat. By allowing the higher ratios of gel material to substrate material as described, the substrate material may also be thinner without adversely affecting stability of the floor mat as a whole. Thus, the floor mat can be thinner while providing sufficient comfort to a subject and being sufficiently stable. More by preference, said deformations protrude towards the center of the gel layer over a distance of between 1.5% and 19.5%, of between 2.0% and 19.0%, of between 2.5% and 18.5%, of between 3.0% and 18.0%, of between 3.5% and 17.5%, of between 4.0% and 17.0%, of between 4.5% and 16.5%, of between 5.0% and 16.0%, of between 5.0% and 15.5%, or of between 5.0% and 15.0% of the total thickness of said gel layer.

According to a further or another embodiment, said deformations define a cushioned surface, which cushioned surface is preferably visible on the exterior of the cover layer. The wording “cushioned surface” herein indicates a surface which provides for a damping effect. The damping effect is particularly relevant when a subject is walking on the floor mat, and aims at absorbing both movement and sound upon walking. Consequently, comfort is improved both from an ergonomic as from an acoustic point of view.

By preference, said cushioned surface comprises a plurality of cushion pads. Such cushion pads are generally enclosed between multiple deformations which are protruding towards the center of the gel layer. Said cushion pads thus form individual, local regions over the surface of the floor mat allowing a further improvement in distributing forces throughout the gel layer and/or in stabilizing the gel layer. This thus allows providing homogeneous comfort and support towards a subject which is standing and/or walking on the floor mat. In particular, a subject will find an equal amount of comfort and support, whatever the position of the subject on the floor mat's surface. More by preference, said cushion pads may form a certain pattern. Said cushioned surface, more in particular said cushion pads, even more in particular said pattern, may or may not be visible on the exterior of the cover layer, thereby visually indicating to a subject that the floor mat is intended to improve comfort, more in particular ergonomics. The cushion pads as described herein may thus have a variety of shapes. Cushion pads may for example have a circular shape wherein the cushion pads are bounded by a single circular deformation of the cover layer. Cushion pads may also have a rectangular shape, wherein the cushion pads are bounded by two pairs of linear deformations of the cover layer, thereby providing for opposite sides of said the rectangular shape. As a further example, cushion pads may have a triangular shape wherein the cushion pads are bounded by three linear deformations of the cover layer.

More by preference, the thickness and the equivalent diameter of said cushion pads are related according to a ratio of between 1:20 and 10:20. The cushion pads are therefore preferably flat in shape, and allow providing a substantially thin floor mat providing homogeneous comfort and support towards a subject. In the light of the present invention, the term “equivalent diameter” indicates the diameter of the largest circle which can be drawn inside the, possibly irregular, shape of the cushion pads. The term “thickness” herein indicates a distance which is measured from the top of the gel layer towards the underside of the lowest deformation adjacent to the respective cushion pad. Even more by preference, the thickness and the equivalent diameter of said cushion pads are related according to a ratio of between 1:20 and 9:20, of between 1:20 and 8:20, of between 1:20 and 7:20, of between 1:20 and 6:20, of between 1:20 and 5:20, of between 1:20 and 4:20, of between 1:20 and 4:20, of between 1:20 and 3:20, or of between 1:20 and 2:20. With increasing preference, the cushion pads as described herein thus allow providing for a flatter floor mat with improved comfort.

With the same purpose as in the first aspect, a second independent aspect of the present invention pertains to a floor mat comprising a substrate layer, a gel layer and a cover layer, wherein said substrate layer, said gel layer and said cover layer have a substantially planar shape, and wherein said gel layer is coupled in between said substrate layer and said cover layer, and wherein the thickness of the gel layer and the thickness of the substrate layer are related according to a ratio of between 1:20 and 20:20. Within the ratios as described, an optimal balance is obtained between stability of the floor and softness, thereby providing optimal comfort to a subject. According to some embodiments, the thickness of the gel layer and the thickness of the substrate layer are related according to a ratio of between 1:20 and 19:20, of between 1:20 and 18:20, of between 1:20 and 17:20, of between 1:20 and 16:20, of between 1:20 and 15:20, of between 1:20 and 14:20, of between 1:20 and 13:20, of between 1:20 and 12:20, or of between 1:20 and 11:20.

According to further or other embodiments of the first or second aspect of the present invention, the thickness of the gel layer and the thickness of the substrate layer are related according to a ratio of between 1:20 and 10:20. The ratios as described herein provide for an optimal balance between rigidity and softness of the floor mat, thereby providing optimal comfort to a subject. By preference, the thickness of the gel layer and the thickness of the substrate layer are related according to a ratio of between 2:20 and 10:20, of between 3:20 and 10:20, of between 4:20 and 10:20, of between 5:20 and 10:20, of between 6:20 and 10:20, of between 7:20 and 10:20, or of between 8:20 and 10:20.

According to still further or other embodiments, the thickness of the cover layer and the thickness of the gel layer are related according to a ratio of between 1:100 and 150:100. The cover layer herein mainly serves to provide a substantially tough upper surface of the floor mat, which ensures integrity of the floor mat upon heavy use, in particular when a subject is standing and/or walking on the floor mat for a prolonged period of time. Within the herein described range, the cover layer is substantially tough without negatively impacting the softness of the floor mat as a whole, thus providing optimal comfort. By preference, the thickness of the cover layer and the thickness of the gel layer are related according to a ratio of between 5:100 and 100:100, of between 5:100 and 90:100, of between 5:100 and 80:100, of between 5:100 and 70:100, of between 5:100 and 60:100, or of between 5:100 and 50:100.

According to still further or other embodiments, the gel layer has a thickness of between 2.0 mm and 20.0 mm. By preference, the gel layer has a thickness of between 5.0 mm and 10.0 mm.

According to still further or other embodiment, the substrate layer has a thickness of between 10.0 mm and 40.0 mm. By preference, the substrate layer has a thickness of between 10.0 mm and 30.0 mm.

The substrate layer of the floor mat according to the first or second aspect of the invention may comprise a polymeric material. By preference, the substrate layer comprises a foamed polymeric material. The use of a polymeric material, in particular a foamed polymeric material, as a substrate layer has certain advantages, among others the provision of a substantially durable material, a substantially light material, and/or a material that is easily manufactured. According to some embodiments, the foamed polymeric material is chosen from the group of ethylene-vinyl acetate (EVA) foam, low-density polyethylene (LDPE) foam, nitrile rubber (NBR) foam, polychloroprene foam, polyimide foam, polypropylene (PP) foam, polystyrene (PS) foam, polyurethane (PU) foam, polyethylene (PE) foam, polyvinyl chloride (PVC) foam, silicone foam, or combinations thereof. More by preference, the substrate layer comprises a foamed polyurethane (PU) material. Even more by preference, the foamed polyurethane (PU) material comprises the reaction product of isocyanate and a polyol in a weight ratio of between 32:100 and 60:100. Withing said ratio range, a substantially durable foam is obtained.

The gel layer of the floor mat according to the first or second aspect of the invention may comprise an oil-based gel, or a polymer-based gel. By preference, the gel layer comprises a polymer-based gel, which is chosen from a silicone-based gel, a polyurethane (PU) based gel, or combinations thereof. More by preference, the gel layer comprises a polyurethane (PU) based gel. Polyurethane (PU) based gels may provide the gel layer of the floor mat with sufficiently soft and/or elastic properties which allow the floor mat to provide substantial comfort towards a subjects which is standing and/or walking on the floor mat. Furthermore, Polyurethane (PU) based gels are sufficiently durable and may withstand heavy duty applications, in particular wherein a subject is standing and/or walking on the floor mat over a prolonged amount of time. More by preference, the polyurethane (PU) based gel comprises the reaction product of isocyanate and a polyol in a weight ratio of between 15:100 and 25:100. Within said ratio range, a substantially soft and durable PU gel is obtained.

The cover layer of the floor mat according to the first or second aspect of the invention may comprise a woven or non-woven material, which woven or non-woven material may comprise natural or polymeric materials, such as polyester, cotton, nylon, or polyurethane (PU). By preference, the cover layer comprises a polyurethane (PU) based fabric.

According to a preferred embodiment of the invention, the assembly of the substrate layer and the cover layer essentially encapsulates the gel layer. Accordingly, the gel layer is tightly fit in between the substrate layer and the cover layer, providing for stable support to a subject which stands and/or walks on the floor mat.

A third aspect of the present invention relates to a method for manufacturing a floor mat comprising the steps of:
(a) providing a mold comprising a first and second mold half;
(b) providing a cover layer on the first mold half;
(c) providing a gel layer onto the cover layer;
(d) providing a substrate layer onto the gel layer;
(e) closing the mold; and
(f) curing the substrate layer;
   wherein the first mold half and/or the cover layer comprises a plurality of deformations, which deformations allow the cover layer to protrude at least partly towards the center of the gel layer.

The method as described herein allows the efficient manufacturing of a floor mat, which combines a substrate layer, a gel layer and a cover layer in a single assembly, providing a subject which is standing and/or walking on said floor mat with a substantial amount of support and comfort. Herein, the deformations which allow the cover layer to protrude at least partly towards the center of the gel layer, allow to manufacture a floor mat wherein forces are better distributed throughout the gel layer, to at least partly stabilize the gel layer's shape and/or to keep the gel layer better in place when a subjects stands and/or walks on the floor mat. Improved comfort is especially relevant in working environments wherein a subject has to stand upright during longer periods of time.

A particular advantage of the method according to the third aspect of the invention exists in that the floor mat is already formed in its final shape from the onset, i.e. by using the plurality of deformations of the first mold half and/or of the cover layer. As both the gel layer and the substrate layer are formed in its final shapes from the onset, i.e. they need not be deformed afterwards, the present method allows to control optimal material characteristics, such as durability of the several layers, as well as the right amount of support and/or comfort the floor mat will eventually provide towards a subject.

According to a preferred embodiment, the first mold half comprises a plurality of deformations, wherein the cover layer is provided as a curable liquid. Herein, the method allows the efficient and straightforward formation of a cover layer comprising a plurality of deformations, which at least partly protrude towards the center of the gel layer, and thereby provide for a floor mat which combines the features of both stability, softness, and thus improved comfort towards a subject which is standing and/or walking on said floor mat. It may be possible that the deformations of the first mold half are interchangeable and/or removable. As such, the position of deformations can be changed in order to obtain various product qualities, such as improved firmness, stability or softness, possibly in specific areas of the floor mat.

According to another preferred embodiment, the cover layer is provided as a preformed layer, which comprises a plurality of deformations. In such a case, the first mold half need not be adapted in order to obtain various product qualities of the final floor mat. Instead, cover layers with various deformations and/or deformation patterns can be introduced inside the mold in order to obtain various product qualities.

According to a further or another embodiment, said plurality of deformations allow the cover layer to protrude towards the center of the gel layer over a distance of between 1% and 20% of the total thickness of said gel layer. Within said range optimal stability is achieved and higher ratios of gel material to substrate material can be applied. More in particular, as a floor mat is preferably not too thick, i.e. to allow a subject to easily stand and/or walk on the floor mat, protrusion of deformations of the cover layer towards the center of the gel layer over the described distance range allows the ratio of gel material to substrate material to be higher. As such, this may allow the substrate material to be thinner without adversely affecting stability of the floor mat as a whole, and thus to provide for a thinner floor mat in general. More by preference, said deformations protrude towards the center of the gel layer over a distance of between of between 1.5% and 19.5%, of between 2.0% and 19.0%, of between 2.5% and 18.5%, of between 3.0% and 18.0%, of between 3.5% and 17.5%, of between 4.0% and 17.0%, of between 4.5% and 16.5%, of between 5.0% and 16.0%, of between 5.0% and 15.5%, or of between 5.0% and 15.0% of the total thickness of said gel layer.

According to a further or another embodiment, said plurality of deformations define a cushioned surface, which cushioned surface is preferably visible on the exterior of the cover layer. The cushioned surface herein provides for a damping effect. The damping effect is particularly relevant when a subject is walking on the floor mat, and aims at absorbing both movement and sound upon walking. Consequently, comfort is improved both from an ergonomic as from an acoustic point of view.

By preference, said cushioned surface comprises a plurality of cushion pads. Such cushion pads are generally enclosed between multiple deformations which are protruding towards the center of the gel layer. Said cushion pads thus form individual, local regions over the surface of the floor mat allowing a further improvement in distributing forces throughout the gel layer and/or in stabilizing the gel layer. This thus allows providing homogeneous comfort and support towards a subject which is standing and/or walking on the floor mat. In particular, a subject will find an equal amount of comfort and support, whatever the position of the subject on the floor mat's surface. More by preference, said cushion pads may form a certain pattern. Said cushioned surface, more in particular said cushion pads, even more in particular said pattern, may or may not be visible on the exterior of the cover layer, thereby visually indicating to a subject that the floor mat is intended to improve comfort, more in particular ergonomics. The cushion pads as described herein may thus have a variety of shapes. Cushion pads may for example have a circular shape wherein the cushion pads are bounded by a single circular deformation of the cover layer. Cushion pads may also have a rectangular shape, wherein the cushion pads are bounded by two pairs of linear deformations of the cover layer, thereby providing for opposite sides of said the rectangular shape. As a further example, cushion pads may have a triangular shape wherein the cushion pads are bounded by three linear deformations of the cover layer.

More by preference, the thickness and the equivalent diameter of said cushion pads are related according to a ratio of between 1:20 and 10:20. The cushion pads are therefore preferably flat in shape, and allow providing a substantially thin floor mat providing homogeneous comfort and support towards a subject. In the light of the present invention, the term “equivalent diameter” indicates the diameter of the largest circle which can be drawn inside the, possibly irregular, shape of the cushion pads. The term “thickness” herein indicates a distance which is measured from the top of the gel layer towards the underside of the lowest deformation adjacent to the respective cushion pad. Even more by preference, the thickness and the equivalent diameter of said cushion pads are related according to a ratio of between 1:20 and 9:20, of between 1:20 and 8:20, of between 1:20 and 7:20, of between 1:20 and 6:20, of between 1:20 and 5:20, of between 1:20 and 4:20, of between 1:20 and 4:20, of between 1:20 and 3:20, or of between 1:20 and 2:20. With increasing preference, the cushion pads as described herein thus allow providing for a flatter floor mat with improved comfort.

With the same purpose as in the third aspect, a fourth independent aspect of the present invention pertains to a method for manufacturing a floor mat comprising the steps of:
(a) providing a mold comprising a first and second mold half;
(b) providing a cover layer on the first mold half;
(c) providing a gel layer onto the cover layer;
(d) providing a substrate layer onto the gel layer;
(e) closing the mold; and
curing the substrate layer;
   wherein the thickness of the gel layer and the thickness of the substrate layer are related according to a ratio of between 1:20 and 20:20.

Within the ratios as described, an optimal balance is obtained between stability of the floor and softness, thereby providing optimal comfort to a subject. According to some embodiments, the thickness of the gel layer and the thickness of the substrate layer are related according to a ratio of between 1:20 and 19:20, of between 1:20 and 18:20, of between 1:20 and 17:20, of between 1:20 and 16:20, of between 1:20 and 15:20, of between 1:20 and 14:20, of between 1:20 and 13:20, of between 1:20 and 12:20, or of between 1:20 and 11:20.

According to further or other embodiments of the third or fourth aspect of the present invention, the thickness of the gel layer and the thickness of the substrate layer are related according to a ratio of between 1:20 and 10:20. The ratios as described herein provide for an optimal balance between rigidity and softness of the floor mat, thereby providing optimal comfort to a subject. By preference, the thickness of the gel layer and the thickness of the substrate layer are related according to a ratio of between 2:20 and 10:20of between 3:20 and 10:20, of between 4:20 and 10:20, of between 5:20 and 10:20, of between 6:20 and 10:20, of between 7:20 and 10:20, or of between 8:20 and 10:20.

According to still further or other embodiments, the thickness of the cover layer and the thickness of the gel layer are related according to a ratio of between 1:100 and 150:100. The cover layer herein mainly serves to provide a substantially tough upper surface of the floor mat, which ensures integrity of the floor mat upon heavy use, in particular when a subject is standing and/or walking on the floor mat for a prolonged period of time. Within the herein described range, the cover layer is substantially tough without negatively impacting the softness of the floor mat as a whole, thus providing optimal comfort. By preference, the thickness of the cover layer and the thickness of the gel layer are related according to a ratio of between 5:100 and 100:100, of between 5:100 and 90:100, of between 5:100 and 80:100, of between 5:100 and 70:100, of between 5:100 and 60:100, or of between 5:100 and 50:100.

According to still further or other embodiments, the gel layer has a thickness of between 2.0 mm and 20.0 mm. By preference, the gel layer has a thickness of between 5.0 mm and 10.0 mm.

According to still further or other embodiment, the substrate layer has a thickness of between 10.0 mm and 40.0 mm. By preference, the substrate layer has a thickness of between 10.0 mm and 30.0 mm.

According to some embodiments, the substrate layer may comprise a polymeric material. By preference, the substrate layer comprises a foamable polymeric material. The use of a polymeric material, in particular a foamable polymeric material, as a substrate layer has certain advantages, among others the provision of a substantially durable material, a substantially light material, and/or a material that is easily manufactured. More in particular, in relation to the methods according to the third and/or fourth aspect of the invention, the substrate material being provided as a foamable polymeric material, allows the easy formation of a substantially durable and light layer inside a mold, thus determining a required shape from the onset. As such, the methods of the invention provide for a fast and efficient manufacturing of a floor mat.

According to some embodiments, the foamable polymeric material is chosen from the group of ethylene-vinyl acetate (EVA), low-density polyethylene (LDPE), nitrile rubber (NBR), polychloroprene, polyimide, polypropylene (PP), polystyrene (PS), polyurethane (PU), polyethylene (PE), polyvinyl chloride (PVC), silicone, or combinations thereof. More by preference, the substrate layer comprises a foamable polyurethane (PU) material. Even more by preference, the foamable polyurethane (PU) comprises a mixture of isocyanate and a polyol, which are reacted with one another following a weight ratio of between 32:100 and 60:100. Withing said ratio range, a substantially durable foam is obtained. Foaming may be obtained by the presence of one or more blowing agents in the mixture of isocyanate and polyol.

The gel layer of step (c) according to third and/or fourth aspect of the invention may comprise an oil-based gel, or a polymer-based gel. By preference, the gel layer comprises a polymer-based gel, which is chosen from a silicone-based gel, a polyurethane (PU) based gel, or combinations thereof. More by preference, the gel layer comprises a polyurethane (PU) based gel. Polyurethane (PU) based gels may provide the gel layer of the floor mat with sufficiently soft and/or elastic properties which allow the floor mat to provide substantial comfort towards a subjects which is standing and/or walking on the floor mat. Furthermore, Polyurethane (PU) based gels are sufficiently durable and may withstand heavy duty applications, in particular wherein a subject is standing and/or walking on the floor mat over a prolonged amount of time. Furthermore, polyurethane (PU) based gels may be easily manufactured inside a mold and thus can be formed in their final, intended shape from the onset. More by preference, the polyurethane (PU) based gel comprises a mixture of isocyanate and a polyol, which are reacted with one another following a weight ratio of between 15:100 and 25:100. Within said ratio range, a substantially soft and durable PU gel is obtained.

The cover layer of step (b) according to the third and/or fourth aspect of the invention may comprise a woven or non-woven material, which woven or non-woven material may comprise natural or polymeric materials, such as polyester, cotton, nylon, or polyurethane (PU). By preference, the cover layer comprises a polyurethane (PU) based fabric.

According to a further or other embodiment of the third or fourth aspect of the invention, in between the steps (c) and (d), and/or in between the steps (d) and (e), a release agent is applied to the second mold half. The release agent allows for an easy removal of the cured floor mat from the mold.

It may be that the release agent is applied to the second mold half in between the steps (c) and (d). Alternatively or additionally, it may be that the release agent is applied to the second mold half in between the steps (d) and (e). Possibly, the release agent is applied to the second mold half both in between the steps (c) and (d), and in between de steps (d) and (e).

According to some embodiments, the curing in step (f) is achieved at a temperature of between 40° C. and 50° C. According to some embodiments, the curing in step (f) is achieved at a pressure of between 0.6 and 0.8 MPa. According to some embodiments, the curing in step (f) is executed for a duration of between 3 and 8 minutes.

According to a preferred embodiment, the curing in step (f) is achieved at a temperature of between 40° C. and 50° C., at a pressure of between 0.6 MPa and 0.8 MPa, and for a duration of between 3 and 8 minutes.

According to some embodiments, the gel layer is cured inside the open mold in between the steps (c) and (d) for a duration of between 30 and 90 seconds.

According to some embodiments, during step (b) the cover layer is kept in place inside the second mold half by means of a vacuum applied to the underside of the cover layer.

In order to better demonstrate the features of the invention, some preferred embodiments are described below, by way of example without any limiting character, with reference to the accompanying drawings, wherein:

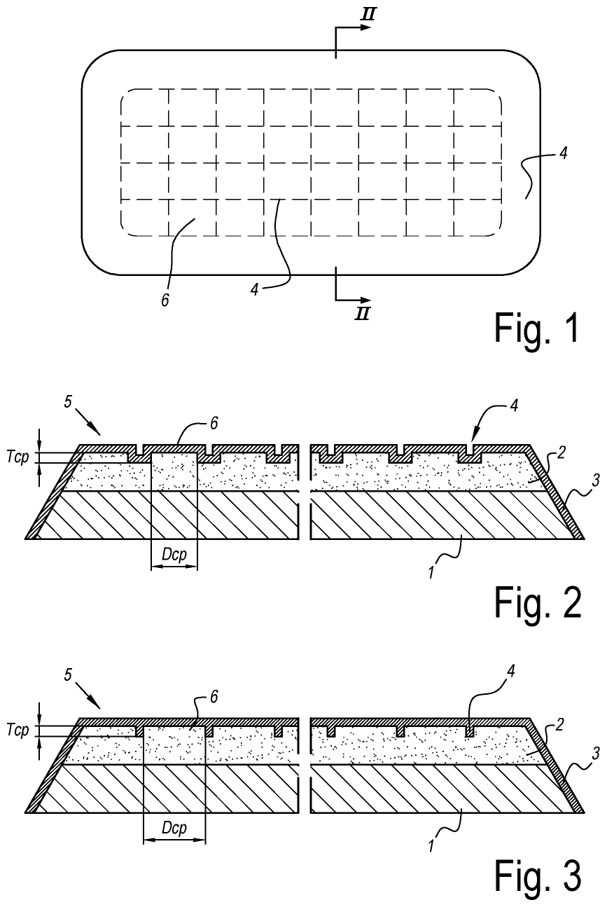

FIG. 1 illustrates a top view of an exemplary floor mat according to some embodiments of the invention,

FIG. 2 illustrates a cross-sectional view along line II-II as shown in FIG. 1,

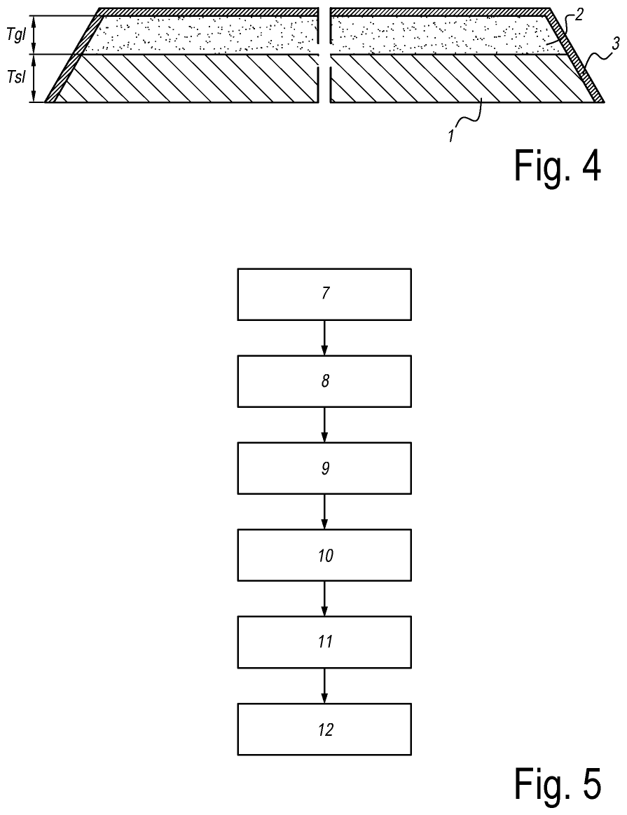

FIGS. 3 and 4 illustrate variants following the same view as in FIG. 2,

FIG. 5 illustrates a schematic view of an exemplary method for manufacturing a floor mat according to one embodiment,

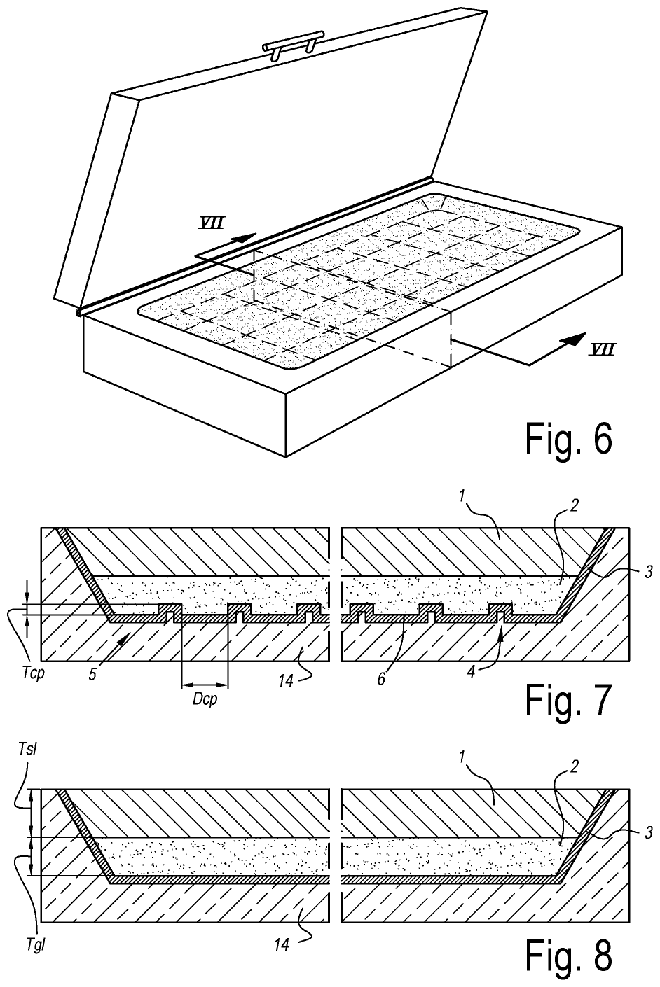

FIG. 6 illustrates a perspective view of a mold as used in a method for manufacturing a floor mat according to some embodiments,

FIG. 7 illustrates a cross-sectional view along line VII-VII as shown in FIG. 6, and

FIG. 8 illustrates a variant following the same view as in FIG. 7.

FIGS. 1 and 2-4 respectively illustrate a top view and a various cross-sectional views along line II-II of a floor mat, showing a substrate layer 1, a gel layer 2 and a cover layer 3. The substrate layer 1, the gel layer 2 and the cover layer 3 each have a substantially planar shape, and the gel layer 2 is coupled in between said substrate layer 1 and said cover layer 3. As shown in FIGS. 2-3, the cover layer 3 comprises a plurality of deformations 4, which deformations 4 protrude towards the center of the gel layer 2, over a distance of between 1% and 20% of the total thickness of the gel layer 2, e.g. a distance of about 10% of the total thickness of the gel layer 2. Said deformations 4 may define a cushioned surface 5, which is preferably visible on the exterior of the cover layer 3, said cushioned surface 5 comprising a plurality of cushion pads 6. The cushion pads 6 preferably have a thickness (Tcp) and an equivalent diameter (Dcp) which are related according to a ratio of between 1:20 and 10:20, e.g. a ratio of about 5:20.

FIG. 2 shows an exemplary embodiment wherein the cushion pads 6 are visible on the exterior of cover layer 3, while FIG. 3 shows an exemplary embodiment wherein the cushion pads 6 are not visible on the exterior of cover layer 3. FIG. 4 illustrates another exemplary embodiment, showing a substrate layer 1, a gel layer 2 and a cover layer 3, wherein the substrate layer 1, the gel layer 2 and the cover layer 3 each have a substantially planar shape, and the gel layer 2 is coupled in between said substrate layer 1 and said cover layer 3. The embodiment as shown in FIG. 4 does not comprise particular deformations of the cover layer which protrude towards the center of the gel layer. The thickness of the gel layer (Tgl) and the thickness of the substrate layer (Tsl) are related according to a ratio of between 1:20 and 20:20, e.g. a ratio of about 10:20. The exemplary floor mats of FIGS. 1-4 preferably have a substrate layer 1 which comprises a foamed polyurethane (PU) material. Such a polyurethane (PU) material may comprise the reaction product of isocyanate and a polyol in a weight ratio of between 32:100 and 60:100. The exemplary floor mats of FIGS. 1-14 preferably have a gel layer 2 which comprises a polyurethane (PU) based gel. Such a polyurethane (PU) based gel may comprise the reaction product of isocyanate and a polyol in a weight ratio of between 15:100 and 25:100. The exemplary floor mats of FIGS. 1-4 preferably have cover layer 3 which comprises a polyurethane (PU) based fabric.

FIG. 5 illustrates a schematic view of a method for manufacturing a floor mat, showing step 7 of providing a mold comprising a first and second mold half; step 8 of providing a cover layer on the first mold half; step 9 of providing a gel layer onto the cover layer; step 10 of providing a substrate layer onto the gel layer; step 11 of closing the mold; and step 12 of curing the substrate layer. Although not specifically illustrated, in between step 9 of providing a gel layer onto the cover layer and step 10 of providing a substrate layer onto the gel layer, and/or in between step 10 of providing a substrate layer onto the gel layer and step 11 of closing the mold, a release agent may be applied to the second mold half 15. Preferably, step 12 of curing the substrate layer is achieved at a temperature of between 40° C. and 50° C., and at a pressure of between 0.6 MPa and 0.8 MPa, for a duration of between 3 and 8 minutes. Although not specifically illustrated, in between step 9 of providing a gel layer onto the cover layer and step 10 of providing a substrate layer onto the gel layer, the gel layer may be cured inside the open mold for a duration of between 30 and 90 seconds.

As shown in FIG. 6, such a mold 13 comprises a first 14 and second mold half 15, wherein the several layers of the floor mat can be formed. More in particular, FIG. 7 illustrates a cross-sectional view along line VII-VII of a mold 13, wherein the first mold half 14 may comprise deformations 4 wherein the cover layer 3 is provided as a curable liquid. In an alternative embodiment, which is not illustrated, the cover layer 3 may be provided as a preformed layer which comprises the plurality of deformations 4. In such a case, the first mold half 14 need not to comprise deformations 4 as such. It is furthermore shown in FIG. 6 that said plurality of deformations 4 allow the cover layer 3 to protrude towards the center of the gel layer 2 over a distance of between 1.0% and 20.0% of the total thickness of the gel layer 2, e.g. over a distance of about 10.0% of the total thickness of the gel layer 2. Said deformations 4 may define a cushioned surface 5, which is preferably visible on the exterior of the cover layer 3, said cushioned surface 5 comprising a plurality of cushion pads 6. The cushion pads 6 preferably have a thickness (Tcp) and an equivalent diameter (Dcp) which are related according to a ratio of between 1:20 and 10:20, e.g. a ratio of about 5:20. FIG. 8 shows a variant, wherein a mold 13 comprises a first 14 and second mold half 15, which first mold half 14 does not comprise particular deformations. The thickness of the gel layer (Tgl) and the thickness of the substrate layer (Tsl) are related according to a ratio of between 1:20 and 20:20, e.g. a ratio of about 10:20. The substrate layer 1 may be formed by reacting a mixture of isocyanate and a polyol, following a weight ratio of between 32:100 and 60:100. The gel layer 2 may be formed by reacting a mixture of isocyanate and a polyol following a weight ratio of between 15:100 and 25:100. The cover layer may comprise a polyurethane (PU) based fabric.

The present invention is by no means limited to the embodiments described above, however a floor mat, as well as methods for manufacturing a floor mat can be realized according to various variants without departing from the scope of the present invention.

1-29. (canceled)

30. A floor mat comprising a substrate layer, a gel layer and a cover layer, wherein the substrate layer, the gel layer and the cover layer have a substantially planar shape, and wherein the gel layer is coupled in between the substrate layer and the cover layer, wherein:
a) the cover layer comprises a plurality of deformations, which deformations protrude at least partly towards a center of the gel layer,
b) the deformations protrude towards the center of the gel layer over a distance of between 1.0% and 20.0% of a total thickness of the gel layer, and
c) the deformations define a cushioned surface comprised of a plurality of cushion pads, wherein a thickness and an equivalent diameter of the cushion pads are related according to a ratio of between 1:20 and 10:20.

31. The floor mat according to claim 30, wherein the cushioned surface is visible on an exterior of the cover layer.

32. The floor mat according to claim 31, wherein the substrate layer comprises a foamed polyurethane (PU) material.

33. The floor mat according to claim 32, wherein the foamed polyurethane (PU) material comprises a reaction product of isocyanate and a polyol in a weight ratio of between 32:100 and 60:100.

34. The floor mat according to claim 33, wherein the gel layer comprises a polyurethane (PU) based gel.

35. The floor mat according to claim 34, wherein the polyurethane (PU) based gel comprises a reaction product of isocyanate and a polyol in a weight ratio of between 15:100 and 25:100.

36. The floor mat according to claim 35, wherein the cover layer comprises a polyurethane (PU) based fabric.

37. A method for manufacturing a floor mat comprising:
(a) providing a mold comprising a first and second mold half;
(b) providing a cover layer on the first mold half;
(c) providing a gel layer onto the cover layer;
(d) providing a substrate layer onto the gel layer;
(e) closing the mold; and
(f) curing the substrate layer;
wherein the first mold half and/or the cover layer comprises a plurality of deformations, which deformations allow the cover layer to protrude over a distance of between 1.0% and 20.0% of a total thickness of the gel layer towards a center of the gel layer; and
the deformations define a cushioned surface comprised of a plurality of cushion pads, wherein a thickness and an equivalent diameter of the cushion pads are related according to a ratio of between 1:20 and 10:20

38. The method according to claim 37, wherein the first mold half comprises a plurality of deformations, wherein the cover layer is provided as a curable liquid.

39. The method according to claim 37, wherein the cover layer is provided as a preformed layer, which comprises a plurality of deformations.

40. The method according to claim 38, wherein the cushioned surface is visible on an exterior of the cover layer.

41. A method for manufacturing a floor mat comprising:
(a) providing a mold comprising a first and second mold half;
(b) providing a cover layer on the first mold half;
wherein the cover layer provides a plurality of deformations;
(c) providing a gel layer onto the cover layer;
(d) providing a substrate layer onto the gel layer;
(e) closing the mold; and
(f) curing the substrate layer; and
wherein:
a thickness of the gel layer and a thickness of the substrate layer are related according to a ratio of between 1:20 and 10:20, and
the deformations define a cushioned surface comprised of a plurality of cushion pads, wherein the plurality of deformations allow the cover layer to protrude towards a center of the gel layer over a distance of between 1.0% and 20.0% of a total thickness of the gel layer.

42. The method according to claim 41, wherein the substrate layer comprises a mixture of isocyanate and a polyol, which are reacted with one another following a weight ratio of between 32:100 and 60:100.

43. The method according to claim 42, wherein the gel layer comprises a mixture of isocyanate and a polyol, which are reacted with one another following a weight ratio of between 15:100 and 25:100.

44. The method according to claim 43, wherein the cover layer comprises a polyurethane (PU) based fabric.

45. The method according to claim 44, wherein in between the steps (c) and (d), and/or in between the steps (d) and (e), a release agent is applied to the second mold half.

46. The method according to claim 45, wherein curing in step (f) is achieved at a temperature of between 40° C. and 50° C., and at a pressure of between 0.6 MPa and 0.8 MPa, for a duration of between 3 and 8 minutes.

47. The method according to claim 46, wherein the gel layer is cured inside the open mold in between the steps (c) and (d) for a duration of between 30 and 90 seconds.

48. The method according to claim 47 wherein a floor mat according to claim 30 is obtained.
